(19) United States
(12) Patent Application Publication
(10) Pub. No.: US 2008/0253449 A1
(43) Pub. Date: Oct. 16, 2008

(54) Information apparatus and method

(76) Inventors: Yoji Shimizu, Kanagawa (JP); Gregory Stupka, Indian Head Park, IL (US); James Kuch, Wheaton, IL (US)

Correspondence Address: FROMMER LAWRENCE & HAUG LLP, 745 FIFTH AVENUE, NEW YORK, NY, 10151, US

(21) Appl. No.: 11/787,051

(22) Filed: Apr. 13, 2007

(51) Int. Cl. H04B 1/66

(52) U.S. Cl. 375/240.03

(57) ABSTRACT

Before a start frame from which decoding of a bit stream is to be started and a reference image frame which is decoded in order to obtain a reference image necessary to decode the start frame are decoded, a quantization matrix stored in a quantization matrix buffer is updated such that, where a quantization matrix is described in any of B pictures disposed between the start frame to be decoded or the reference image frame and an I picture or a P picture preceding in time to the start frame or the reference image frame, the start frame and the reference image frame are decoded with the quantization matrix described in the B picture. Then, where a quantization matrix is described in the frame to be decoded, a decoding process of the bit stream is performed using the quantization matrix and the quantization matrix buffer is updated using the quantization matrix. However, where a quantization matrix is not described in the frame to be decoded, a decoding process of the bit stream is performed using the quantization matrix stored in the quantization matrix buffer.

### BACKGROUND OF THE INVENTION

1. Field of the Invention

This invention relates to a decoding apparatus and a decoding method, an information processing apparatus and an information processing method.

2. Description of the Related Art

In a Long GOP stream of the MPEG (Moving Picture Experts Group), the values of a quantization matrix are referred to execute decoding. The quantization matrix is an 8×8 matrix used for quantization upon encoding and decoding of MPEG (Moving Picture Experts Group) stream data.

A quantization matrix described in a bit stream is described with reference to FIG. 1. A Long GOP stream of the MPEG normally has information of a quantization matrix (quantization matrix Q1 in FIG. 1) in the sequence header of an I picture at the top of a GOP. Further, also in a GOP, when a change of the quantization matrix occurs intermediately, information of the quantization matrix (quantization matrices Q2 and Q2′ in FIG. 1) is described in the picture header of a P picture or a B picture. However, in the other pictures which do not include a change of the quantization matrix from that of a preceding picture, data of the quantization matrix are not described in the picture header frequently.

Two different kinds of quantization matrices including an intra quantization matrix and a non-intra quantization matrix can be set not only in the sequence header of an I picture but also in the picture header of an I picture, a P picture of a B picture. Further, in a 4:2:2 stream or a 4:4:4 stream, since the luminance (quantization matrix Q2 in FIG. 1) and the color difference (quantization matrix Q2′ in FIG. 1) can be defined separately from each other as described in a B6 picture in FIG. 1, four different kinds of quantization matrices in the maximum can be set in the picture header depending upon the combination of the intra and non-intra types and the luminance and color difference.

A quantization matrix described in the picture header (for example, the quantization matrix Q2 or Q2′ in FIG. 1) is also called extended quantization matrix.

Where a quantization matrix included in a stream may not be utilized as it is, basically the quantization matrix described in the stream is utilized to execute encoding and decoding of the stream.

Further, where a changed quantization matrix is described in the picture header of a B6 picture intermediately of a GOP as seen in FIG. 2, those pictures from an I2 picture at the top of the GOP to a P8 picture are encoded using a quantization matrix Q1 set at the I2 picture. Then, those pictures from the B6 picture to a B13 picture are encoded using another quantization matrix Q2 set at the B6 picture. Accordingly, in order to reproduce the GOP normally, it is necessary to perform decoding using the quantization matrix Q1 from the I2 picture to the P8 picture and using the quantization matrix Q2 from the B6 picture to the B13 picture.

Where random reproduction is started from one of the pictures from the B7 picture to the B13 picture, since the quantization matrix Q2 is not detected upon decoding in any picture and also in any picture which is used as a reference picture, quantization is performed using the quantization matrix Q1, resulting in deterioration of the picture quality.

### SUMMARY OF THE INVENTION

Where an MPEG stream is decoded, if the quantization matrix changes intermediately of the stream, then decoding is thereafter performed using the changed quantization matrix described in the picture header of the like. However, for example, where the quantization matrix changes at a B picture intermediately of a stream and the values of the quantization matrix to be utilized thereafter are described in the picture header of the B picture, if decoding of the B picture is not executed in random reproduction or the like but decoding is executed beginning with another picture which is to be decoded using the same quantization matrix, then the decoding is performed using the wrong quantization matrix. Consequently, normal reproduction may not be performed.

The present invention has been made in view of such situations as described above and makes it possible to prevent deterioration of the picture quality also in random reproduction.

A decoding apparatus of the present invention is a decoding apparatus for decoding a bit stream, which includes bit stream acquisition means for acquiring the bit stream, quantization matrix updating means for updating, before a start frame from which decoding of the bit stream is to be started and a reference image frame which is decoded in order to obtain a reference image necessary to decode the start frame are decoded respectively, a quantization matrix stored in a quantization matrix buffer such that, where a quantization matrix is described in any of B pictures disposed between the start frame to be decoded or the reference image frame and an I picture or a P picture preceding in time to the start frame or the reference image frame, the start frame and the reference image frame are decoded with the quantization matrix described in the B picture, and decoding processing means for performing, where a quantization matrix is described in the frame to be decoded, a decoding process of the bit stream using the quantization matrix and updating the quantization matrix buffer using the quantization matrix, but performing, where a quantization matrix is not described in the frame to be decoded, a decoding process of the bit stream using the quantization matrix stored in the quantization matrix buffer.

With the decoding apparatus of the present invention, a bit stream can be decoded, and particularly a quantization described in a frame which is not decoded can be applied correctly to perform a decoding process.

An information processing apparatus of the present invention is an information processing apparatus for producing information to be used where a bit stream is decoded, which includes bit stream acquisition means for acquiring the bit stream, and production means for deciding whether or not a quantization matrix is described in any of B pictures included in the bit stream acquired by the bit stream acquisition means and producing information indicative of those B picture which has a quantization matrix described in a picture header.

With the information processing apparatus, information to be used for decoding can be produced. Particularly in an apparatus wherein information representative of a B picture having a quantization matrix described in a picture header thereof is acquired and a decoding process is performed for the information, a quantization matrix described in a frame which is not decoded can be applied correctly to perform a decoding process.

### BRIEF DESCRIPTION OF THE DRAWINGS

FIG. 1 is a view illustrating a quantization matrix.

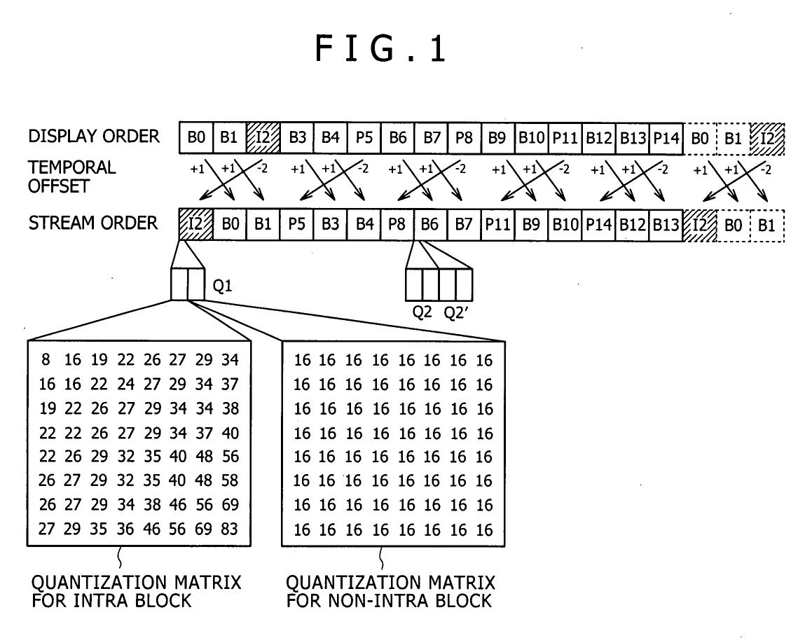

FIG. 2 is a view illustrating a quantization matrix.

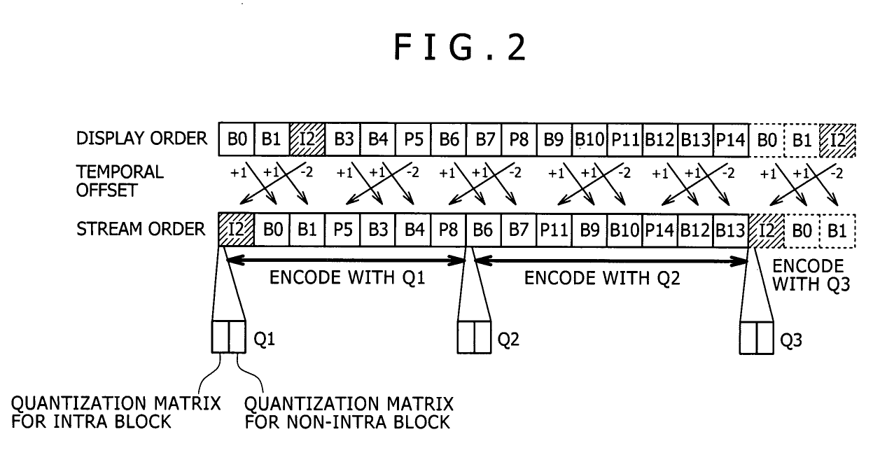

FIG. 3 is a block diagram showing a configuration of a decoding processing system.

FIG. 4 is a functional block diagram of a bit stream analysis apparatus of FIG. 3.

FIG. 5 is a view illustrating. index data.

FIG. 6 is a functional block diagram of a decoder of FIG. 3.

FIG. 7 is a view illustrating existing random decoding.

FIG. 8 is a view illustrating existing random decoding.

FIG. 9 is a view illustrating random decoding where index data is used.

FIG. 10 is a view illustrating random decoding where index data is used.

FIG. 11 is a view illustrating random decoding where index data is used.

FIG. 12 is a block diagram showing a configuration of a personal computer.

FIG. 13 is a first example of a functional block diagram illustrating functions of the personal computer of FIG. 12.

FIG. 14 is a second example of a functional block diagram illustrating functions of the personal computer of FIG. 12.

FIG. 15 is a third example of a functional block diagram illustrating functions of the personal computer of FIG. 12.

FIG. 16 is a flow chart illustrating an index data production process.

FIG. 17 is a flow chart illustrating a decoding process.

FIG. 18 is a flow chart illustrating the decoding process.

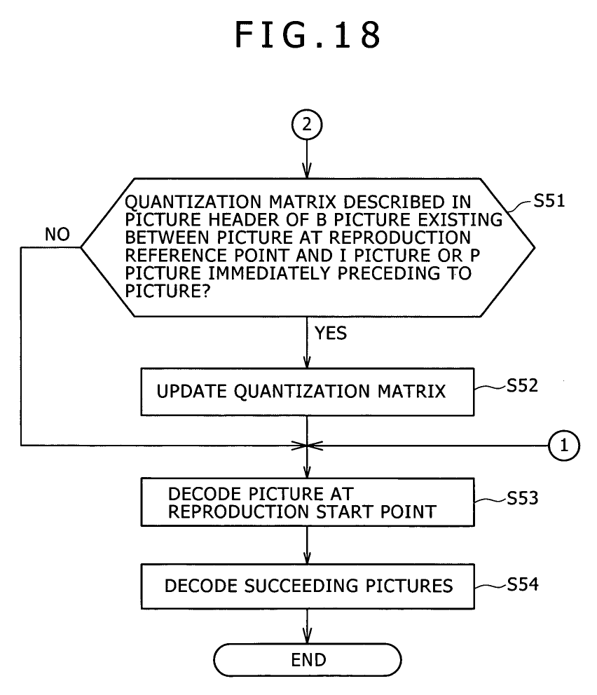

### DETAILED DESCRIPTION OF THE PREFERRED EMBODIMENT

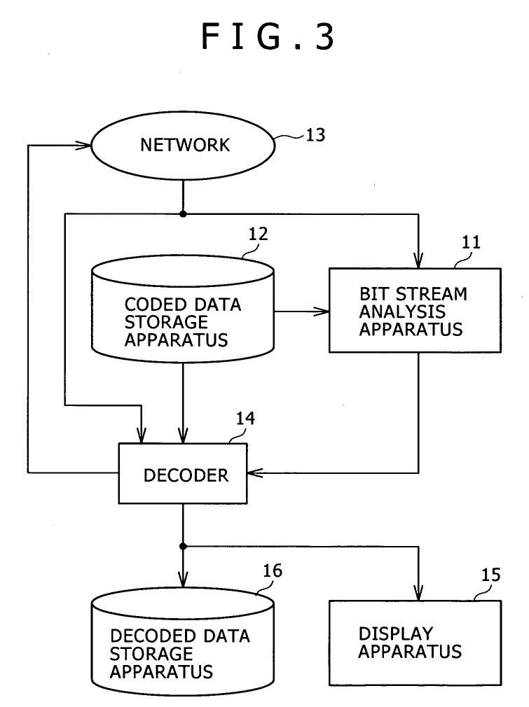

FIG. 3 is a block diagram showing a configuration of a decoding processing system.

A bit stream analysis apparatus 11 acquires a compression coded stream (hereinafter referred to as bit stream) file stored in a coded data storage apparatus 12 or supplied from another apparatus through a network 13. Then, the bit stream analysis apparatus 11 analyzes header information of the bit stream file to decide whether or not a quantization matrix (hereinafter referred to suitably also as Q matrix) exists in the picture header of B pictures. Then, the bit stream analysis apparatus 11 produces index data which is information representative of in which one of B frames a quantization matrix exists, and supplies the index data to a decoder 14.

The decoder 14 refers to the index data supplied from the bit stream analysis apparatus 11 to decode a compression coded stream stored in the coded data storage apparatus 12 or supplied from another apparatus through the network 13. Then, the decoder 14 outputs the decoded stream to a display apparatus 15 so as to be displayed or supplies the decoded stream to a decoded data storage apparatus 16 so as to be stored or else supplies the decoded stream to another apparatus through the network 13.

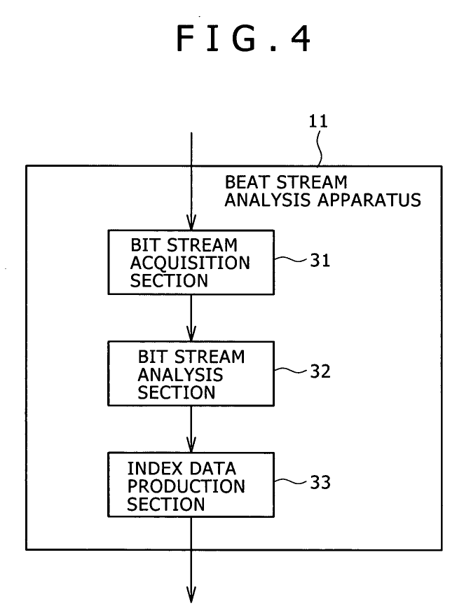

FIG. 4 shows a functional block diagram of the bit stream analysis apparatus 11. In particular, the bit stream analysis apparatus 11 may include functions of sections shown in FIG. 4 in the form of hardware or may include functions of sections shown in FIG. 4 by executing a program by means of a computer.

The bit stream analysis apparatus 11 includes a bit stream acquisition section 31, a bit stream analysis section 32 and an index data production section 33.

The bit stream acquisition section 31 acquires a bit stream file stored in the coded data storage apparatus 12 or supplied from another apparatus through the network 13 and supplies the acquired bit stream file to the bit stream analysis section 32.

The bit stream analysis section 32 has a stream buffer for buffering a bit stream file acquired by the bit stream acquisition section 31. The bit stream analysis section 32 analyzes header information of frames read into the stream buffer and supplies, if an extended quantization matrix exists in the picture header of any B picture, then the bit stream analysis section 32 supplies information indicative of the B picture to the index data production section 33.

The index data production section 33 produces an index file based on a result of the analysis by the bit stream analysis section 32 and outputs the index file. The index file describes index data which is information indicative of a B picture which has an extended quantization matrix in the picture head thereof in the bit stream.

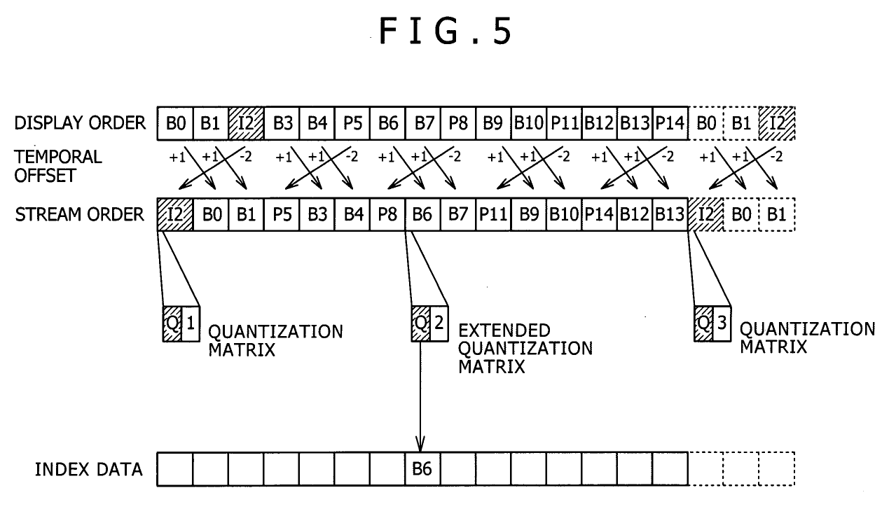

Production of index data is described below with reference to FIG. 5.

The index data does not include an extended quantization matrix itself described in the picture header of a B picture but is information which indicates which any of B pictures of a bit stream supplied has an extended quantization matrix. For example, the index data may be a one-bit flag (quantization matrix flag) set corresponding to each of frames which form a bit stream such that 1 is set for the bit corresponding to a B picture which has an extended quantization matrix while 0 is set for any other bit. For example, the index data may otherwise be table information which describes information indicative of what numbered frame in a GOP a B picture which has an extended quantization matrix is. Or else, the index data may be represented in any other data format to indicate a B picture which has an extended quantization matrix.

For example, where index data formed from a quantization matrix flag is produced, if it is analyzed by the bit stream analysis section 32 that not only a quantization matrix is described in the sequence header of an I picture at the top of a GOP but also an extended quantization matrix Q2 is described in the picture head of the B6 picture, the index data production section 33 sets the quantization matrix flag to the position of the B6 picture in the index data.

Here, for example, even if the index data production section 33 extracts an extended quantization matrix from a B picture which has the extended quantization matrix and produces index data in which the extended quantization matrix itself is described and then uses the index data upon decoding, a correct quantization matrix can be utilized where the decoder 14 performs random decoding hereinafter described. However, since the quantization matrix has a comparatively great information amount. among parameters which are used upon encoding or decoding, for example, when an extended quantization matrix is described in the picture header of all B pictures, the data amount of the index data in which the extended quantization matrix itself is described is very great. In contrast, while the data amount of index data formed from the quantization matrix flag described hereinabove with reference to FIG. 5 is very small, even where information of the data amount which is small in this manner is used, when the decoder 14 hereinafter described performs random decoding, a correct quantization matrix can be utilized by using the index data.

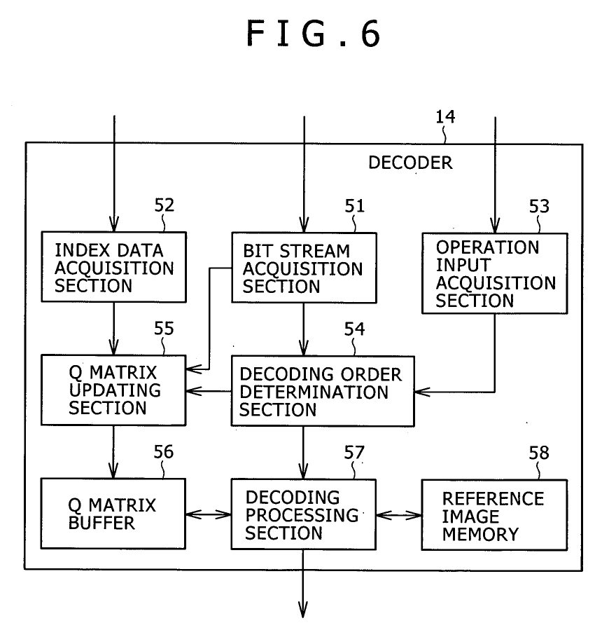

FIG. 6 shows a functional block diagram of the decoder 14. In particular, the decoder 14 may include sections shown in FIG. 6 in the form of hardware or may include functions of sections shown in FIG. 6 by executing a program by means of a computer.

The decoder 14 includes functions of a bit stream acquisition section 51, an index data acquisition section 52, an operation input acquisition section 53, a decoding order determination section 54, a Q matrix updating section 55, a Q matrix buffer 56, a decoding processing section 57 and a reference image memory 58.

The bit stream acquisition section 51 acquires a bit stream file stored in the coded data storage apparatus 12 or supplied from another apparatus through the network 13 and supplies the acquired bit stream file to the decoding order determination section 54 and the Q matrix updating section 55.

The index data acquisition section 52 acquires index data produced by the bit stream analysis apparatus 11 and supplies the index data to the Q matrix updating section 55.

The operation input acquisition section 53 is formed from, for example, a keyboard and a mouse or a reception section which receives a signal signaled from a remote commander not shown. The operation input acquisition section 53 receives an operation input of a user such as an instruction of a reproduction start point of a bit stream and supplies the operation input to the decoding order determination section 54.

The decoding order determination section 54 determines the order of frames to be decoded in a bit stream supplied from the bit stream acquisition section 51 based on an operation input of a user such as an instruction of a reproduction start point of the bit stream supplied from the operation input acquisition section 53. The decoding order determination section 54 supplies the determined decoding order to the Q matrix updating section 55 and the decoding processing section 57. Further, the decoding order determination section 54 supplies data of a frame to be decoded from within a bit stream supplied from the bit stream acquisition section 51 based on the determined decoding order to the decoding processing section 57.

More particularly, for example, if an instruction to start reproduction from the B6 picture is received, then since it is necessary to first decode a reference image necessary to decode the B6 picture, the decoding order determination section 54 determines the decoding order such that an I2 picture, a P5 picture and a P8 picture of the GOP are decoded first and the B6 picture is decoded, whereafter pictures which follow the B6 picture are decoded. Then, the decoding order determination section 54 supplies the determined decoding order to the Q matrix updating section 55 and the decoding processing section 57 and supplies the pictures corresponding to the determined decoding order to the decoding processing section 57.

The Q matrix updating section 55 supplies, based on the index data acquired by the index data acquisition section 52 and the order of frames to be decoded which is determined by the decoding order determination section 54, an extended quantization matrix described in the picture header of a B picture from within the bit stream supplied from the bit stream acquisition section 51 to the Q matrix buffer 56 as occasion demands. Consequently, the quantization matrix retained in the Q matrix buffer 56 is updated.

In particular, when random decoding is to be executed, where a picture of a reference image necessary to decode a reproduction start picture and the reproduction start picture are to be decoded, the Q matrix updating section 55 refers to the index data acquired by the index data acquisition section 52 to decide whether or not an extended quantization matrix is described in one of B pictures existing between an I picture or a P picture immediately preceding to the picture to be decoded and the picture to be decoded. Then, if an extended quantization matrix is described in any of B pictures existing between the I picture or P picture immediately preceding to the picture to be decoded and the picture to be decoded, then the Q matrix updating section 55 supplies the extended quantization matrix described in the picture header of the B picture from within the bit stream supplied from the bit stream acquisition section 51 to the Q matrix buffer 56 to update the quantization matrix retained in the Q matrix buffer 56.

Where a picture of a reference image necessary to decode a reproduction start picture and the reproduction start picture are decoded, B pictures existing between an I picture or a P picture immediately preceding to the picture to be decoded and the picture to be decoded are, in other words, a picture of a reference image necessary to decode a reproduction start picture and those pictures which are disposed successively preceding to the reproduction start picture and are not decoded upon random decoding.

It is to be noted that the Q matrix updating section 55 is preferably configured such that, in addition to the case wherein random decoding is executed, also where some frame in a GOP intermediately during reproduction is not decoded such as upon double-speed reproduction, where an extended quantization matrix is described in any of B pictures which exist between an I picture or a P picture immediately preceding to the picture to be decoded and the picture to be decoded are not decoded, the Q matrix updating section 55 supplies an extended quantization matrix described in the picture header of the corresponding B picture to the Q matrix buffer 56 so that the Q matrix retained in the Q matrix buffer 56 is updated.

The Q matrix buffer 56 is a buffer for retaining a quantization matrix to be utilized in a decoding process executed by the decoding processing section 57.

It is to be noted that, since index data is referred to from a portion corresponding to a frame disposed earlier in time, the Q matrix buffer 56 is updated such that, also where an extended quantization matrix is described in a plurality of B pictures existing between an I picture or a P picture immediately preceding to the picture to be decoded and the picture to be decoded, the picture to be decoded is decoded using an extended quantization matrix described in a B picture which precedes in time to and is nearest to the picture to be decoded.

The decoding processing section 57 uses a quantization matrix described in the sequence header or the picture header or a quantization matrix retained in the Q matrix buffer 56 and a reference image held in the reference image memory 58 to decode a bit stream supplied from the decoding order determination section 54 in a decoding order determined by the decoding order determination section 54 and outputs the decoded bit stream. In particular, when a quantization matrix is described in the sequence header of the frame to be decoded or in the picture header, the decoding processing section 57 uses the quantization matrix to perform a decoding process and supplies the quantization matrix to the Q matrix buffer 56 to update the quantization matrix retained in the Q matrix buffer 56. On the other hand, when a quantization matrix is not described in the sequence header of the frame to be decoded or the picture header, the decoding processing section 57 uses a quantization matrix (including an extended quantization matrix) held in the Q matrix buffer 56 to perform a decoding process. Then, when decoded frame data are utilized as a reference image of pictures to be decoded thereafter, the decoding processing section 57 supplies the decoded frame data as a reference image to the reference image memory 58.

The reference image memory 58 is a frame memory for retaining a reference image to be utilized in a decoding process to be executed by the decoding processing section 57.

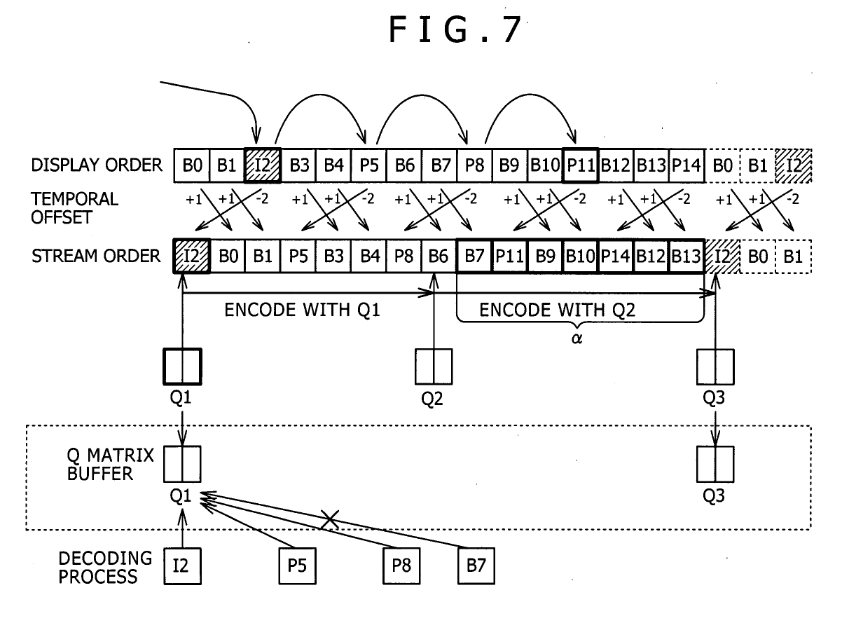

An existing decoding process and an updating and decoding process of the Q matrix buffer 56 executed by the decoder 14 are described in connection with particular examples with reference to FIGS. 7 to 11 for comparison.

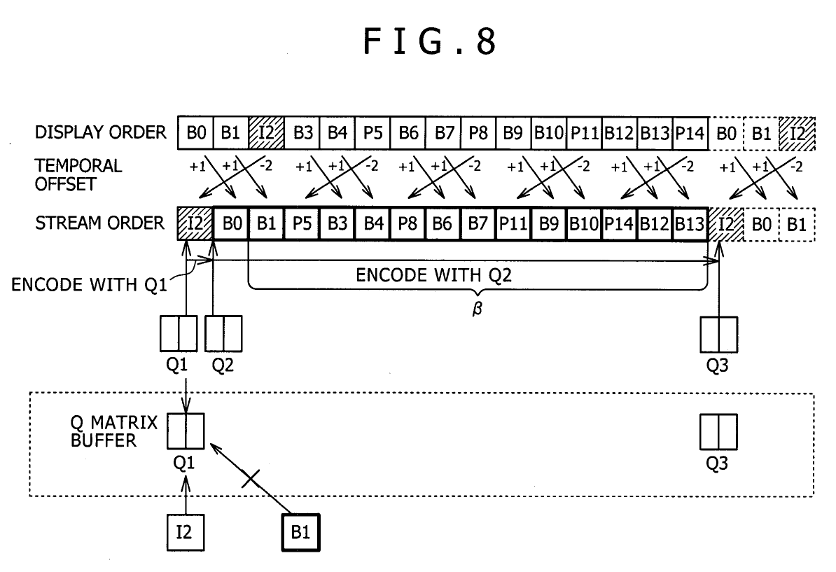

First, an existing decoding process when an instruction to start reproduction from an intermediate portion of a GOP is described with reference to FIGS. 7 and 8.

In the existing decoding process, where a quantization matrix is described in the sequence header or the picture header of a picture to be decoded, the quantization matrix is read in and decoding is performed using the quantization matrix until after a new quantization matrix is read in.

The existing decoding process wherein random decoding is executed by a method which is executed in the past for an MPEG Long GOP wherein information of an extended quantization matrix Q2 which is a quantization matrix having values different from those of a quantization matrix Q1 is described in the B6 picture is described with reference to FIG. 7.

Where an extended quantization matrix Q2 is described in the B6 picture, the pictures from the I2 picture to the P8 picture are in a form encoded using the quantization matrix Q1 described in the sequence header of the I2 picture and therefore should be decoded based on the quantization matrix Q1. On the other hand, the frames from the B6 picture to the end point of the GOP should be encoded based on the encoded quantization matrix Q2 described in the picture header of the B6 picture and therefore should be decoded based on the extended quantization matrix Q2.

Here, for example, where the B7 picture is designated as the reproduction start position, the I2, P5 and P8 pictures from which a reference image is to be produced are decoded correctly based on the quantization matrix Q1. However, since the B6 picture is not decoded, the extended quantization matrix Q2 included in the B6 picture is not read in. Accordingly, the quantization matrix retained in the B6 picture is not updated, and when the decoded P5 and P8 pictures are referred to decode the B7 picture, although the B7 picture should originally be decoded using the extended quantization matrix Q2, it is decoded using the quantization matrix Q1.

Similarly, when an instruction is issued to start reproduction from any of pictures within an interval of the pictures B7 to B13 indicated by α in FIG. 7, similarly as in the case wherein the B7 picture is designated as the reproduction start point, the pictures mentioned and the reference images are decoded using the quantization matrix Q1. Also where, for example, the P11 picture is the reproduction start picture, since the extended quantization matrix Q2 described in the B6 picture is not read in, the quantization matrix retained in the Q matrix buffer 56 is not updated. Consequently, although the P11 picture should originally be decoded using the extended quantization matrix Q2, it is decoded using the quantization matrix Q1.

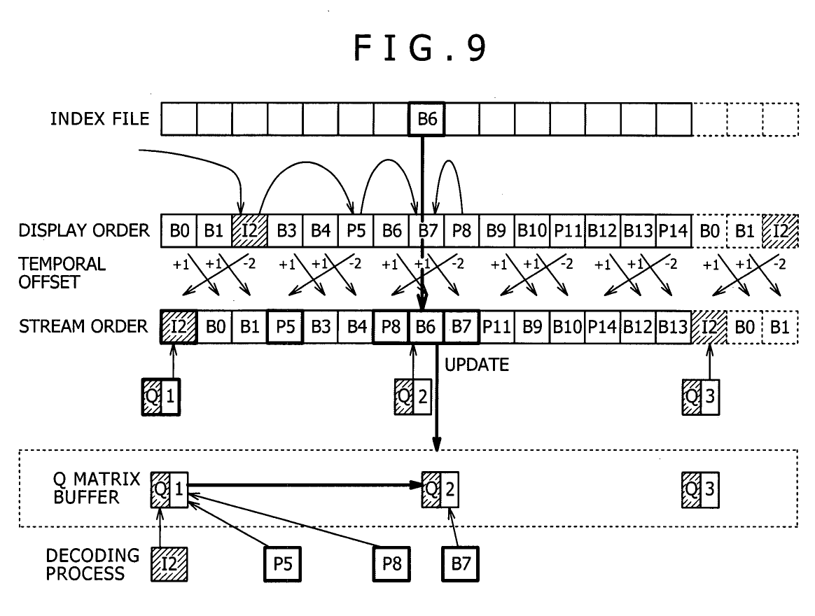

The most extreme example is that random decoding is executed for an MPEG Long GOP wherein information of the extended quantization matrix Q2 which is a quantization matrix of values different from those of the quantization matrix Q1 is described in the B0 picture at the top of the GOP. Where the frames beginning with the B0 picture immediately following the I picture at the top of the GOP in this manner are encoded with a quantization matrix different from that of the I picture, even if any of the pictures denoted by β in FIG. 9 from the B1 picture to the next I picture next to the B0 picture in which information of the extended quantization matrix Q2 is described, the pictures which should be decoded with the extended quantization matrix Q2 are decoded with the quantization matrix Q1.

In other words, where, in a stream of the GOP structure (N=15, M=3) used frequently in the MPEG2, all frames other than an I picture are encoded using an extension quantization matrix different from that of the I picture as in the case of the bit stream illustrated in FIG. 8, whichever one of 13 frames is designated as a reproduction start point, there is the possibility that the picture quality of a resulting image may be deteriorated. If this is generalized, where one of frames the number of which is smaller by 2 than that of one GOP is designated as a reproduction start position of random decoding, there is the possibility that a decoder may malfunction and a resulting image may exhibit deteriorated picture quality.

Now, a processing example where random decoding is executed in a decoding process in which an index file described hereinabove is used is described with reference to FIGS. 9 to 11.

The Q matrix updating section 55 refers, where a picture of a reference image necessary to decode a reproduction start picture and the reproduction start picture are to be decoded, to the index data acquired by the index data acquisition section 52 to decide whether or not an extended quantization matrix is described in any of B pictures which exist between an I picture or a P picture immediately preceding to the picture to be decoded and the picture to be decoded are not decoded. Then, when an extension quantization matrix is described in any of the B pictures which are not decoded, the Q matrix updating section 55 supplies the extension quantization matrix described in the picture header of the B picture within the bit stream supplied from the bit stream acquisition section 51 to the Q matrix buffer 56 so that the quantization matrix retained in the Q matrix buffer 56 is updated.

As seen in FIG. 9, when the extended quantization matrix Q2 is described in the B6 picture and the B7 picture is designated as a reproduction start position, since the decoding processing section 57 prepares a reference image prior to the decoding process of the B7 picture, it decodes the I2 picture which does not demand a reference image using the quantization matrix Q1 described in the sequence header of the I2 picture. Then, the decoding processing section 57 stores the quantization matrix Q1 into the Q matrix buffer 56 and supplies the decoded I picture to the reference image memory 58 so as to be stored.

Then, the Q matrix updating section 55 refers to the index data acquired by the index data acquisition section 52 to decide whether or not an extended quantization matrix is described in any of B pictures which exist between each of the P5 and P8 pictures and an I picture or a P picture immediately preceding to the P5 or P8 picture. The Q matrix updating section 55 can detect based on the index data that an extension quantization matrix is not described in any of the corresponding B pictures. Therefore, the decoding processing section 57 decodes the P5 and P8 pictures for production of a reference image based on the quantization matrix Q1 which is described in the sequence header of the I2 picture and was stored into the Q matrix buffer 56 upon decoding of the I picture.

Then, the Q matrix updating section 55 refers to the index data acquired by the index data acquisition section 52 to decide whether or not an extension quantization matrix is described in a B picture which exists between the B7 picture and the P8 picture, that is, in the B6 picture prior to the decoding process of the B7 picture. The Q matrix updating section 55 can detect based on the index data that the extended quantization matrix Q2 is described in the B6 picture. Therefore, the Q matrix updating section 55 supplies the extended quantization matrix Q2 extracted from the index header of the B6 picture to the Q matrix buffer 56 so as to be stored into the Q matrix buffer 56 so that the extended quantization matrix Q2 may be used when the B7 picture is decoded by the decoding processing section 57.

Then, although the B6 picture is not decoded, since the extended quantization matrix Q2 described in the B6 picture is supplied from the Q matrix updating section 55 to the Q matrix buffer 56 and updated in the Q matrix buffer 56, the decoding processing section 57 can decode the B7 picture and succeeding pictures which should originally be decoded using the extended quantization matrix Q2 correctly using the extended quantization matrix Q2.

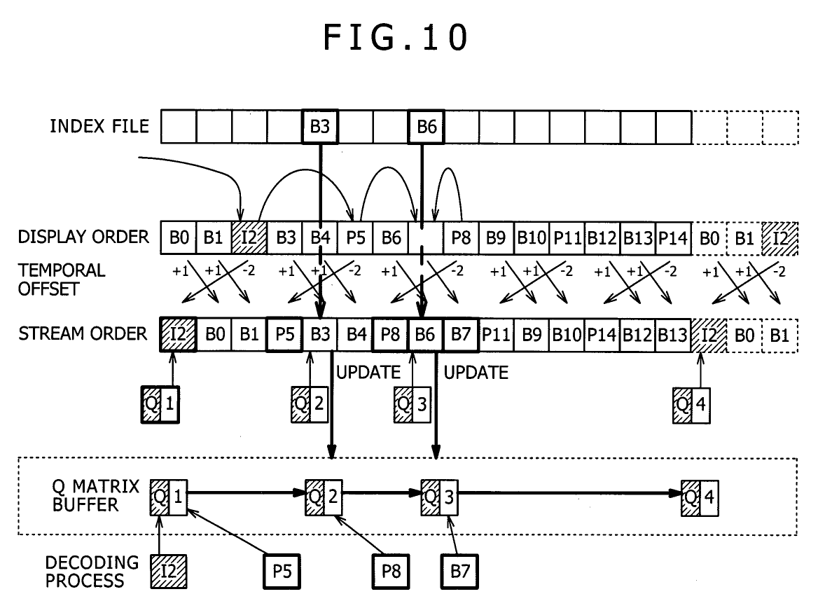

On the other hand, for example, where the extended quantization matrix Q2 is described in the B3 picture while an extended quantization matrix Q3 is described in the B6 picture and the B7 picture is designated as a reproduction start point as seen in FIG. 10, the decoding processing section 57 prepares a reference image prior to a decoding process of the B7 picture. Therefore, the decoding processing section 57 decodes the I2 picture which does not demand a reference image using the quantization matrix Q1 described in the sequence header of the I2 picture and stores the quantization matrix Q1 into the Q matrix buffer 56. Further, the decoding processing section 57 supplies the decoded I picture to the reference image memory 58 so as to be stored.

Then, the Q matrix updating section 55 refers to the index data acquired by the index data acquisition section 52 to decide whether or not an extension quantization matrix is described in the B0 and B1 pictures which exist between the P5 picture and the I picture immediately preceding to the P5 picture. The Q matrix updating section 55 can detect based on the index data that an extension quantization matrix is not described in any of the corresponding B pictures. Therefore, the decoding processing section 57 decodes the P5 picture for producing a reference image based on the quantization matrix Q1 which is described in the sequence header of the I2 picture and was stored into the Q matrix buffer 56 upon decoding of the I picture.

Then, the Q matrix updating section 55 refers to the index data acquired by the index data acquisition section 52 to decide whether or not an extension quantization matrix is described in the B3 and B4 pictures which exist between the P8 picture and the P5 picture which is a P picture immediately preceding to the P8 picture. The Q matrix updating section 55 can detect based on the index data that the extension quantization matrix Q2 is described in the B3 picture. Therefore, the Q matrix updating section 55 supplies the extended quantization matrix Q2 extracted from the sequence header of the B3 picture to the Q matrix buffer 56 so as to be stored into the Q matrix buffer 56 so that the extended quantization matrix Q2 can be utilized when the P8 picture is decoded by the decoding processing section 57. Then, the decoding processing section 57 can decode the P8 picture for production of a reference image correctly using the extended quantization matrix Q2 although the B3 picture is not decoded.

Furthermore, the Q matrix updating section 55 refers to the index data acquired by the index data acquisition section 52 to decide whether or not an extended quantization matrix is described in a B picture which exists between the B7 picture and the P8 picture, that is, in the B6 picture, prior to the decoding process of the B7 picture. The Q matrix updating section 55 can detect based on the index data that the extension quantization matrix Q3 is described in the B6 picture. Therefore, the Q matrix updating section 55 supplies the extended quantization matrix Q3 extracted from the sequence header of the B6 picture to the Q matrix buffer 56 so as to be stored into the Q matrix buffer 56 so that the extended quantization matrix Q3 may be utilized when the B7 picture is decoded by the decoding processing section 57.

Then, although the B6 picture is not decoded, since the extended quantization matrix Q3 described in the B6 picture is supplied from the Q matrix updating section 55 to the Q matrix buffer 56 and updated in the Q matrix buffer 56, the decoding processing section 57 can decode the B7 picture and succeeding pictures which should originally be decoded using the extended quantization matrix Q3 correctly using the extended quantization matrix Q3.

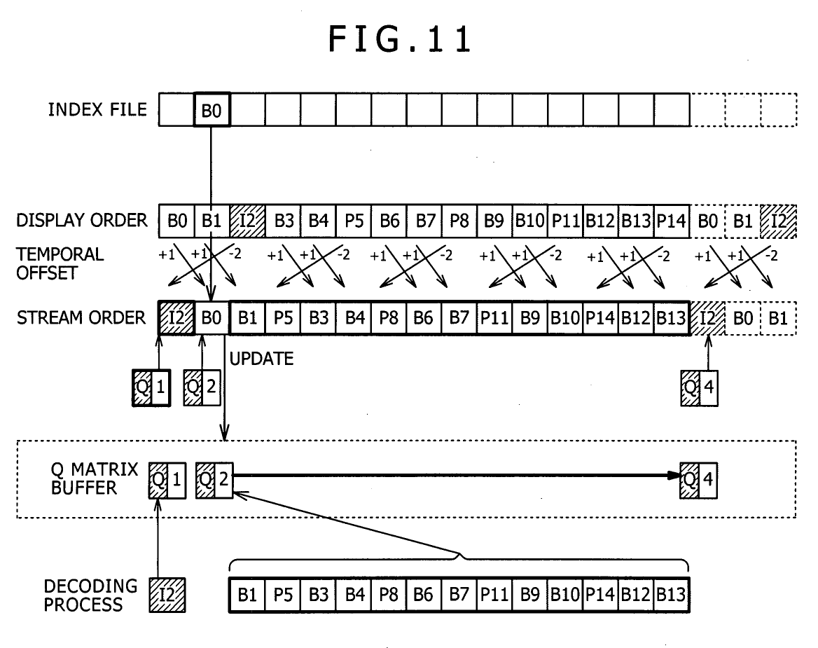

Similarly, also in the extreme example described hereinabove with reference to FIG. 8, that is, also when random decoding is executed for an MPEG Long GOP wherein information of the extended quantization matrix Q2 which is a quantization matrix of values different from those of the quantization matrix Q1 is described in the B0 picture at the top of the GOP, the decoding process can be performed correctly by using the index file.

Where, as seen in FIG. 11, pictures beginning with the B0 picture immediately following the I picture at the top of a GOP are encoded with the extended quantization matrix Q2 different from the quantization matrix Q1 described in the sequence header of the I picture, even if one of pictures denoted by β in FIG. 11 from the B1 picture to a picture immediately preceding to the next I picture following the B0 picture in which information of the extended quantization matrix Q2 is described is selected as a reproduction start point for random reproduction, the Q matrix updating section 55 refers, prior to the decoding process of the B1 picture or the P5 picture, to the index data acquired by the index data acquisition section 52 to decide whether or not an extension quantization matrix is described in any B picture existing between the B1 picture or the P5 picture and the I2 picture, that is, in the B0 picture. The Q matrix updating section 55 can detect based on the index data that the extension quantization matrix Q2 is described in the B0 picture. Therefore, the Q matrix updating section 55 supplies the extended quantization matrix Q2 extracted from the sequence header of the B0 picture to the Q matrix buffer 56 so as to be stored into the Q matrix buffer 56 so that the extended quantization matrix Q2 may be used when the B1 picture or the P5 picture is decoded by the decoding processing section 57.

Then, even where the B0 picture is not decoded, when the pictures following the B0 picture are decoded, since the extended quantization matrix Q2 described in the B0 picture is supplied from the Q matrix updating section 55 to and updated in the Q matrix buffer 56, the decoding processing section 57 can decode the B1 picture or the P5 picture and succeeding pictures correctly using the extended quantization matrix Q2.

It is to be noted that such a processing procedure can be applied not only when random decoding is executed but also when some frame in a GOP during reproduction is not decoded, for example, upon double speed reproduction.

While the series of processes described above can be executed by hardware, it may otherwise be executed by software. Further, the series of processes described above can be executed not by a plurality of apparatus but by a single apparatus.

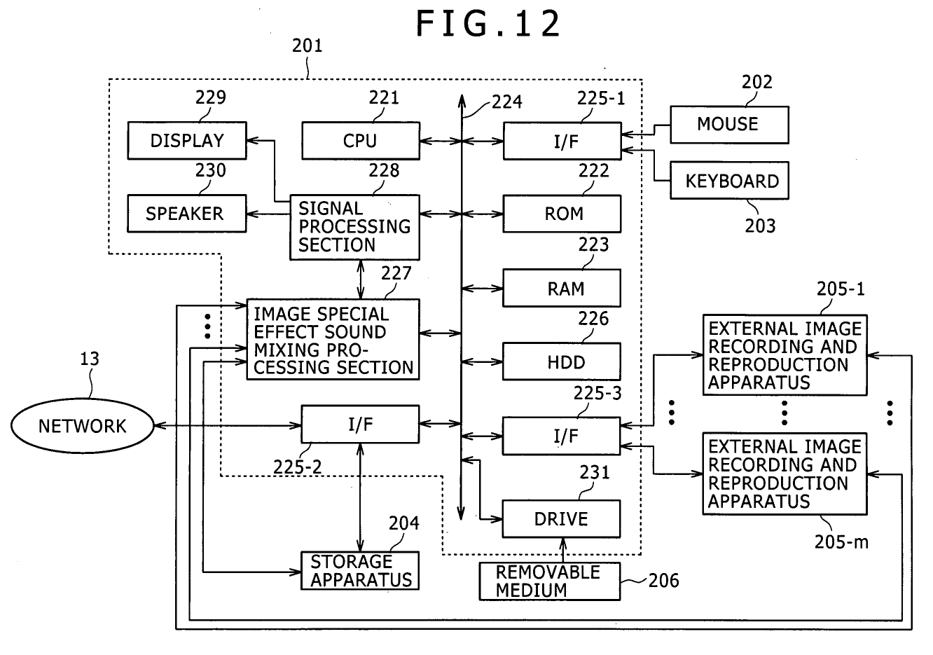

In other words, the processes described hereinabove can be executed entirely or partly by software within one apparatus. In particular, the functions of one of the bit stream analysis apparatus 11 and the decoder 14 or the functions of the entire system described hereinabove with reference to FIG. 3 can be provided by such a personal computer 201 as shown in FIG. 12.

Referring to FIG. 12, a CPU (central processing unit) 221 executes various processes in accordance with a program stored in a ROM (read only memory) 222 or a program loaded from a HDD 226 into a RAM (random access memory) 223. Also data and so forth necessary for the CPU 221 to execute various processes are suitably stored into the RAM 223.

The CPU 221, ROM 222 and RAM 223 are connected to each other by a bus 224. Also interfaces (I/F) 225-1 to 225-3, the HDD (hard disc drive) 226, an image special effect sound mixing processing section 227 and a signal processing section 228 are connected to the bus 224.

Inputting devices such as a mouse 202 and a keyboard 203 are connected to the interface 225-1. A storage apparatus 204 is connected to the interface 225-2 so that information can be communicated with the storage apparatus 204. Meanwhile, external image recording and reproduction apparatus 205-1 to 205-m are connected to the interface 225-3 such that information can be communicated with the external image recording and reproduction apparatus 205-1 to 205-m. The HDD 226 can drive a hard disk to store various kinds of information.

The image special effect sound mixing processing section 227 is connected also to the signal processing section 228, storage apparatus 204 and external image recording and reproduction apparatus 205-1 to 205-m and applies a special effect to an image signal supplied from any of the storage apparatus 204 and the external image recording and reproduction apparatus 205-1 to 205-m or supplied from the HDD 226 through the bus 224 or mixes sound into the image signal. Then, the image special effect sound mixing processing section 227 supplies a resulting signal to the signal processing section 228 so as to be outputted or to any of the storage apparatus 204 and the external image recording and reproduction apparatus 205-1 to 205-m so as to be stored into the same.

The signal processing section 228 is connected also to a display unit 229 and a speaker 230. Thus, the signal processing section 228 supplies an image signal supplied from the image special effect sound mixing processing section 227 or the like to the display unit 229 so as to be displayed on the display unit 229 or supplies a sound signal to the speaker 230 so as to be outputted as sound from the speaker 230.

The display unit 229 is formed from, for example, a CRT (Cathode Ray Tube) or an LCD (liquid crystal display) unit and displays an image supplied from the signal processing section 228. The speaker 230 reproduces and outputs sound supplied from the signal processing section 228.

Further, as occasion demands, a drive 231 is connected to the bus 224. Thus, a removable medium 206 such as a magnetic disk, an optical disk, a magneto-optical disk or a semiconductor memory is suitably loaded into the drive 231, and a computer program read out from the removable medium 206 is installed into the HDD 226 as occasion demands.

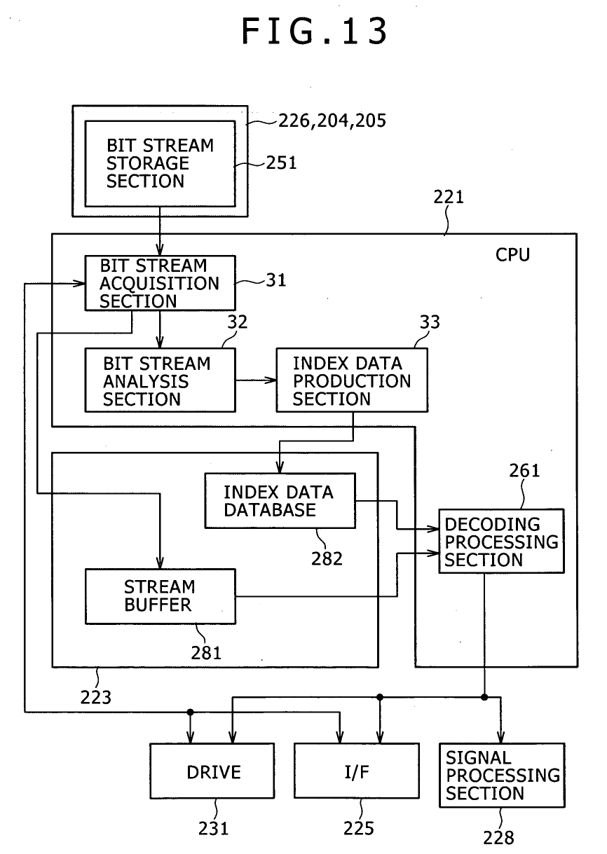

An example of functions of the personal computer 201 described above with reference to FIG. 12 where processes similar to the series of processes executed by the bit stream analysis apparatus 11 described hereinabove are executed by the software so as to produce index data and processes similar to the series of processes executed by the decoder 14 described hereinabove are executed to decode a bit stream based on the thus produced index data is described with reference to FIG. 13.

It is to be noted that elements corresponding to those in FIG. 4, 6 or 12 are denoted by like reference characters and description thereof is omitted suitably.

As a result of execution of a predetermined program by the CPU 221, the personal computer 201 is provided with functions similar to those of the bit stream acquisition section 31, bit stream analysis section 32 and index data production section 33 of FIG. 4 and has functions of the decoding processing section 261 having functions basically equivalent to those of the decoder 14 of FIG. 6.

Further, data storage areas corresponding to a stream buffer 281 which retains a bit stream acquired by the bit stream acquisition section 31 and an index data database 282 for storing index data produced by processing of the index data production section 33 are provided in the RAM 223. It is to be noted that the data storage areas corresponding to the stream buffer 281 and the index data database 282 may be provided not in the RAM 223 but, for example, as a cache memory of the CPU 221.

A decoding processing section 261 acquires a bit stream from the stream buffer 281 and acquires index data from the index data database 282. The decoding processing section 261 further acquires an operation input inputted by the user using the mouse 202, keyboard 203 or the like through the interface 225-1 and the bus 224. Then, the decoding processing section 261 executes processes similar to those of the decoder 14 described hereinabove with reference to FIG. 6 using the acquired bit stream, index data and operation input. Then, the decoding processing section 261 supplies decoded baseband image data produced thereby, for example, to the storage apparatus 204 through the interface 225-2 so as to be stored into the storage apparatus 204. Or, the decoding processing section 261 can supply the decoded baseband image data to an external apparatus through the network 13 or to an external image recording and reproduction apparatus 205 through the interface 225-3 so as to be recorded or reproduced. Further, the decoding processing section 261 can supply the produced decoded baseband image data, for example, to the signal processing section 228 such that the baseband image data may be subject to a predetermined signal process by the signal processing section 228 and supplied to and displayed on the display unit 229 or supplied to the drive 231 so that the baseband image data are supplied to and recorded on a removable medium 206 loaded in the drive 231.

The bit stream acquisition section 31 of the CPU 221 acquires a bit stream stored in an original bit stream storage section 251 which correspond to one of storage areas of the storage apparatus 204, external image recording and reproduction apparatus 205 and HDD 226 or acquires a bit stream transmitted from another apparatus through the interface 225-2 and the network 13 or else acquires a bit stream recorded on the removable medium 206 loaded in the drive 231. Then, the bit stream acquisition section 31 supplies the acquired bit stream to the bit stream analysis section 32 and to the stream buffer 281 of the RAM 223.

The bit stream analysis section 32 of the CPU 221 analyzes header information of the frames of the bit stream supplied thereto. Then, if an extension quantization matrix exists in the picture header of any B picture, then the bit stream analysis section 32 supplies information representative of the B picture to the index data production section 33.

The index data production section 33 produces, based on a result of the analysis by the bit stream analysis section 32, index data which is information representative of the B picture which has an extension quantization matrix in the picture header thereof as described hereinabove with reference to FIG. 5. The index data production section 33 outputs the thus produced index data to the index data database 282 of the RAM 223.

The stream buffer 281 of the RAM 223 buffers the bit stream acquired by the bit stream acquisition section 31 and supplies the buffered bit stream to the decoding processing section 261.

The index data database 282 of the RAM 223 accumulates the index data produced by the index data production section 33 and supplies index data corresponding to the bit stream to be decoded by the decoding processing section 261 to the decoding processing section 261.

The decoding processing section 261 reads out the bit stream for which a decoding process should be performed from the stream buffer 281 of the RAM 223 and reads out the index data corresponding to the bit stream from the index data database 282 of the RAM 223. The decoding processing section 261 has functions equivalent to those of the decoder 14 described hereinabove with reference to FIG. 6.

In particular, in the decoding processing section 261, the bit stream acquisition section 51 acquires a bit stream file while the index data acquisition section 52 acquires index data and the operation input acquisition section 53 receives an operation input of the user such as, for example, an instruction of a reproduction start point of the bit stream. Then, the decoding order determination section 54 determines an order of frames to be decoded and supplies data of a frame to be decoded from within the bit stream supplied from the bit stream acquisition section 51 to the decoding processing section 57 based on the determined decoding order.

Then, when random decoding is to be executed, the Q matrix updating section 55 of the decoding processing section 261 refers to the index data acquired by the index data acquisition section 52 to decide whether or not an extension quantization matrix is described in any of B pictures which exist between an I picture or a P picture immediately preceding to the picture to be decoded and the picture to be decoded where a picture of a reference image necessary to decode the reproduction start picture and the reproduction start picture. Then, where an extension quantization matrix. is described in any of B pictures which exist between the I picture or P picture immediately preceding to the picture to be decoded and the picture to be decoded, the Q matrix updating section 55 supplies the extension quantization matrix described in the picture header of the B picture within the bit stream supplied from the bit stream acquisition section 51 to the Q matrix updating section 55 (although the Q matrix buffer 56 is preferably provided in the cache memory of the CPU 221, it may otherwise be provided in the RAM 223) to update the quantization matrix retained in the Q matrix buffer 56.

Then, the decoding processing section 57 of the decoding processing section 261 uses the quantization matrix described in the sequence header or the picture header or the quantization matrix retained in the Q matrix buffer 56 and refers to the reference image retained in the reference image memory 58 (although preferably this is provided in the cache memory of the CPU 221, it may otherwise be provided in the RAM 223) to decode the bit stream supplied from the decoding order determination section 54 in accordance with the decoding order determined by the decoding order determination section 54.

It is to be noted that the Q matrix updating section 55 of the decoding processing section 261 is preferably configured such that, in addition to the case wherein random decoding is executed, also where some frame in a GOP intermediately during reproduction is not decoded such as, for example, upon double-speed reproduction, when an extended quantization matrix is described in any of B pictures which exist between an I picture or a P picture immediately preceding to the picture to be decoded and the picture to be decoded, the Q matrix updating section 55 supplies an extended quantization matrix described in the picture header of the corresponding B picture to the Q matrix buffer 56 so that the quantization matrix retained in the Q matrix buffer 56 is updated similarly as in the case described hereinabove.

In this manner, since the decoding processing section 261 having functions similar to those of the decoder 14 decodes a bit stream, for example, in such a manner as described hereinabove with reference to FIGS. 9 to 11, also when a random reproduction process is executed, a malfunction caused by reference to a wrong quantization matrix does not occur. Therefore, deterioration of the picture quality can be suppressed when compared with that in the existing system.

The decoded frame image data may be outputted to an external apparatus through an interface 225 or may be recorded into the removable medium 206 through the drive 231. Or, the frame image data may be supplied to the signal processing section 228 such that the frame image data after a predetermined signal process is applied thereto by the signal processing section 228 are supplied to and reproduced by and displayed on the display unit 229.

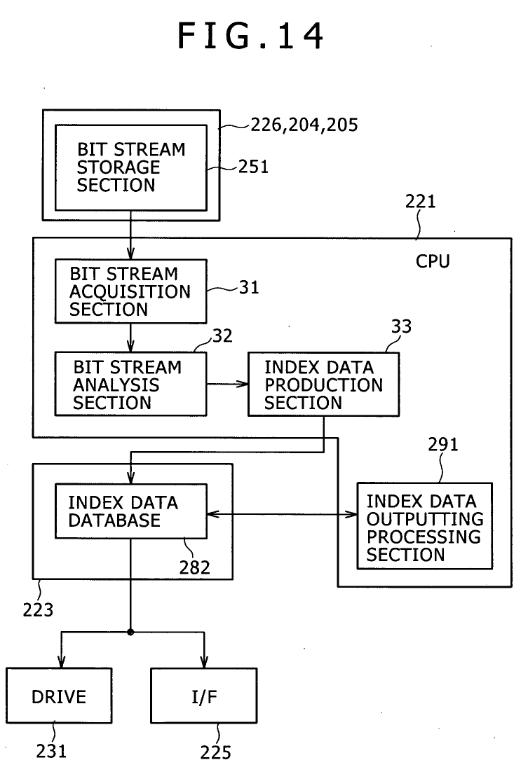

An example of functions of the personal computer 201 described hereinabove with reference to FIG. 12 where processes similar to the series of processes executed by the bit stream analysis apparatus 11 described hereinabove are executed by software to produce index data is described with reference to FIG. 14.

It is to be noted that elements corresponding to those in FIG. 13 are denoted by like reference characters and description thereof is omitted suitably.

The personal computer 201 which can execute processes similar to the series of processes executed by the bit stream analysis apparatus 11 described hereinabove have functions similar to those of a bit stream acquisition section 31, a bit stream analysis section 32, an index data production section 33 and an index data database 282 described hereinabove with reference to FIG. 13. The personal computer 201 further has a function of an index data outputting control section 291.

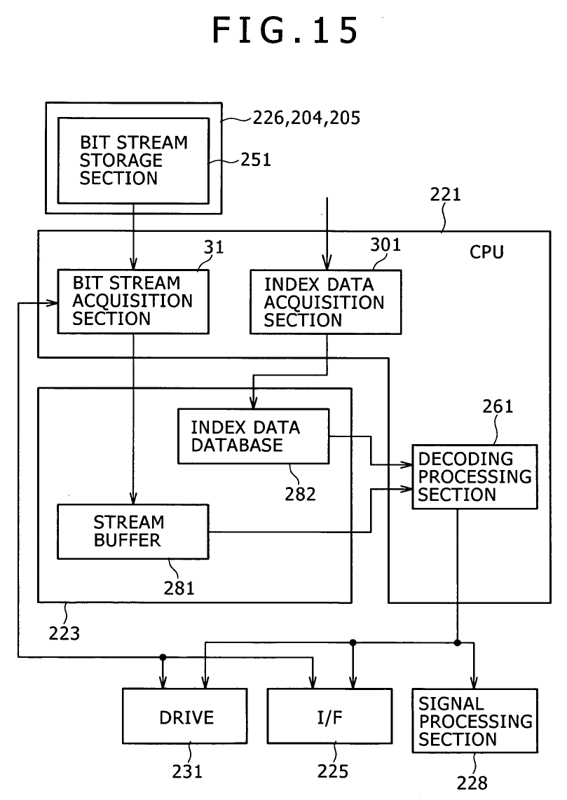

The index data outputting control section 291 controls processing of produced reading out index data from the index data database 282 and outputting the index data to an external apparatus (a decoder 14 or a personal computer 201 having a function equivalent to that of the decoder 14 and hereinafter described with reference to FIG. 15 or some other apparatus).

The personal computer 201 having the functions described above with reference to FIG. 14 can execute processes similar to the series of processes executed by the bit stream analysis apparatus 11 described hereinabove.

Now, a functional block diagram illustrating an example of functions where the personal computer 201 described hereinabove with reference to FIG. 12 executes processes similar to the series of processes executed by the decoder 14 described hereinabove in accordance with software to decode a bit stream based on index data produced by the processes is shown in FIG. 15.

It is to be noted that elements corresponding to those in FIG. 13 are denoted by like reference characters and description thereof is omitted suitably.

In particular, the personal computer 201 which can execute processes similar to the series of processes executed by the decoder 14 described hereinabove has functions of a bit stream acquisition section 31, a decoding processing section 261, a stream buffer 281 and an index data database 282 similar to those described hereinabove with reference to FIG. 13. The personal computer 201 further has a function of an index data acquisition section 301.

The index data acquisition section 301 acquires an index file recorded in a storage area of one of the storage apparatus 204, external image recording and reproduction apparatus 205 and HDD 226 and having index data described therein or acquires an index file transmitted from another apparatus through the interface 225-2 and the network 13 and having index data described therein. Or else, the index data acquisition section 301 acquires an index file recorded in the removable medium 206 loaded in the drive 231 and having index data described therein. Then, the index data acquisition section 301 supplies the acquired index file to the index data database 282 so as to be recorded into the index data database 282.

The personal computer 201 having the configuration described above with reference to FIG. 15 can execute processes similar to the series of processes executed by the decoder 14 described hereinabove.

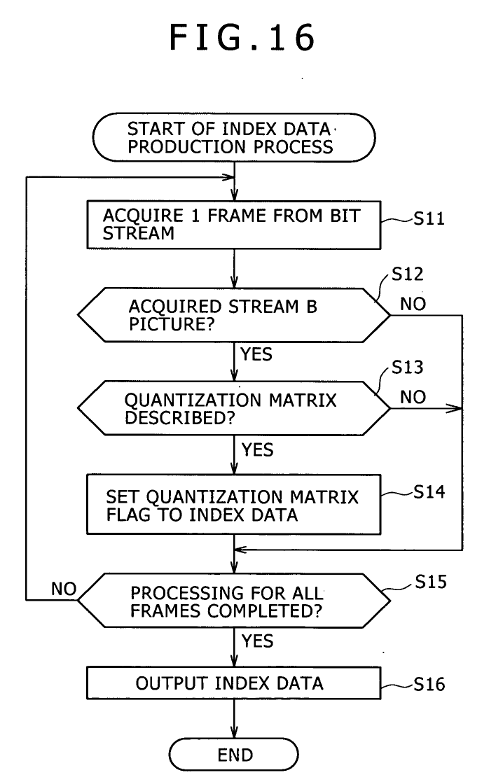

Now, an index data production process executed by the bit stream analysis apparatus 11 or personal computer 201 is described with reference to a flow chart of FIG. 16.

At step S11, the bit stream analysis section 32 acquires frame data of an object of analysis by one frame from a bit stream acquired by the bit stream acquisition section 31 and buffered in the stream buffer.

At step S12, the bit stream analysis section 32 decides whether or not the acquired stream is a B picture.

If it is decided at step S12 that the acquired stream is a B picture, then the bit stream analysis section 32 decides at step S13 whether or not a quantization matrix is described in the picture header of the B picture.

If it is decided at step S13 that a quantization matrix is described in the picture header of the B picture, then the bit stream analysis section 32 supplies information indicative of the B picture to the index data production section 33 at step S14. The index data production section 33 sets the quantization matrix flag to the bit corresponding to the B picture having the quantization matrix of the index data.

On the other hand, if it is decided at step S12 that the acquired stream is not a B picture or if it is decided at step S13 that a quantization matrix is. not described in the picture header of the B picture or else after the processing at step S14 is completed, the processing advances to step S15. At step S15, the bit stream analysis section 32 decides whether or not the processing for all frames of the bit stream file acquired by the bit stream acquisition section 31 and buffered in the stream buffer is completed.

If it is decided at step S15 that the processing for all frames is not completed, then the processing returns to step S11 so that the processes at the steps beginning with step S11 are repeated.

On the other hand, if it is decided at step S15 that the processing for all frames is completed, then the processing advances to step S16. At step S16, the index data production section 33 produces, based on a result of the analysis by the bit stream analysis section 32, an index file in which index data which is information representing the B picture which has an extended quantization matrix in the picture header thereof is described. The index data production section 33 outputs the produced index file and ends the processing.

Index data is produced as described hereinabove with reference to FIG. 5 by such processes as described above.

It is to be noted that, while it is described here that an index file in which index data is described is produced and outputted, where the decoder 14 which performs a decoding process hereinafter described or the decoding processing section 261 of the personal computer 201 is configured so as to directly handle index data, the index data production section 33 may directly output produced index data.

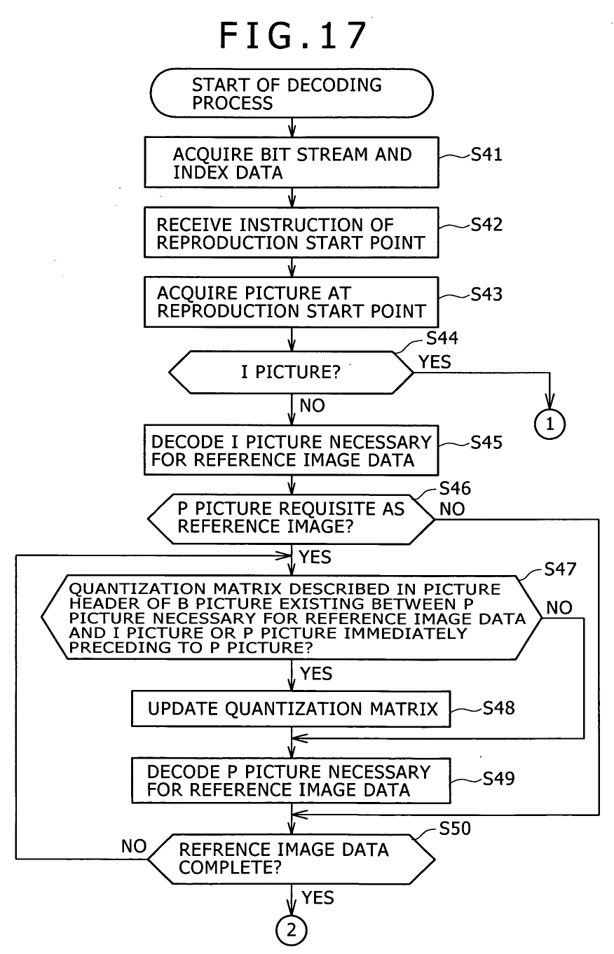

Now, a decoding process executed by the decoder 14 or a decoding processing section of a personal computer is described with reference to a flow chart of FIG. 17.

At step S41, the bit stream acquisition section 51 acquires a bit stream to be decoded, and the index data acquisition section 52 acquires index data. The index data acquisition section 52 may acquire the entire index file in which index data is described or may acquire the index data described in the index file or else may accept supply only of index data.

At step S42, the operation input acquisition section 53 receives an instruction of a reproduction start point of the bit stream. from the user and supplies the instruction to the decoding order determination section 54. The decoding order determination section 54 determines an order of frames to be decoded in the bit stream supplied from the bit stream acquisition section 51 and supplies the determined decoding order to the Q matrix updating section 55 and the decoding processing section 57. Further, the decoding order determination section 54 supplies, based on the determined decoding order, data of a frame to be decoded from within the bit stream supplied from the bit stream acquisition section 51 to the decoding processing section 57.

At step S43, the decoding processing section 57 acquires a picture at the reproduction start point.

At step S44, the decoding processing section 57 decides based on the decoding order determined by the decoding order determination section 54 whether or not the picture at the reproduction start point is an I picture. If it is decided at step S44 that the picture at the reproduction start point is an I picture, then the processing advances to step S53 hereinafter described.

If it is decided at step S44 that the picture at the reproduction start point is not an I picture, then the decoding processing section 57 decodes an I picture necessary for reference image data at step S45. At this time, the decoding processing section 57 uses the quantization matrix described in the sequence header or the picture header of the I picture to perform a decoding process and supplies the quantization matrix to the quantization matrix buffer 56 to update the quantization matrix.

At step S46, the decoding processing section 57 decides based on the decoding order determined by the decoding order determination section 54 whether or not a P picture is requisite as a reference image. If it is decided at step S46 that a P picture is not requisite, then the processing advances to step S50 hereinafter described.

If it is decided at step S46 that a P picture is requisite as a reference image, then the Q matrix updating section 55 refers to the index data at step S47 to decide whether or not a quantization matrix is described in the picture header of B pictures which exist between the P picture necessary for reference image data and the I picture or P picture immediately preceding to the P picture.

If it is decided at step S47 that a quantization matrix is described in the picture header of any of the B pictures, then the Q matrix updating section 55 supplies, at step S48, the extended quantization matrix described in the picture header of the B picture from within the bit stream supplied form the bit stream acquisition section 51 to the Q matrix buffer 56 to update the quantization matrix retained in the Q matrix buffer 56.

If it is decided at step S47 that a quantization matrix is not described in the picture header of the B pictures or after the processing at step S48 is completed, the processing advances to step S49, at which the decoding processing section 57 decodes the P picture necessary for reference image data. At this time, if a quantization matrix is described in the picture header of the P picture, then the decoding processing section 57 supplies the quantization matrix to the Q matrix buffer 56 to update the quantization matrix.

If it is decided at step S46 that a P picture is not requisite or after the processing at step S49 is completed, the decoding processing section 57 decides at step S50 whether or not reference image data necessary to decode the picture at the reference start point are complete. If it is decided at step S50 that reference image data are not complete, then the processing returns to step S47 to repeat the processes at the steps beginning with step S47.

If it is decided at step S50 that reference image data are complete, then the Q matrix updating section 55 refers to the index data at step S51 to decide whether or not a quantization matrix is described in the picture header of B pictures existing between the picture at the reproduction reference point and the I picture or P picture immediately preceding to the picture at the reproduction start point.

If it is decided at step S51 that a quantization matrix is described in the picture header of the B pictures, then the Q matrix updating section 55 supplies, at step S52, an extended quantization matrix described in the picture header of the B picture from within the bit stream supplied from the bit stream acquisition section 51 to the Q matrix buffer 56 to update the quantization matrix retained in the Q matrix buffer 56.

If it is decided at step S44 that the picture at the reproduction start point is an I picture, or if it is decided at step S51 that a quantization matrix is not described in the picture header of the B pictures or after the processing at step S52 comes to an end, the decoding processing section 57 decodes the picture at the reproduction start point at step S53. At this time, if a quantization matrix is described in the sequence header or the picture header of the picture at the reproduction start point, then the decoding processing section 57 uses the quantization matrix to perform a decoding process and supplies the quantization matrix to the Q matrix buffer 56 to update the quantization matrix.

Then, at step S54, the decoding processing section 57 decodes the succeeding pictures and then ends the processing.

By such processes as described above, even if random decoding is executed and an extended quantization matrix is described in the picture header of a frame which is not decoded, a quantization matrix can be updated based on index data which is information representative of a B picture in which the extended quantization matrix is described. Therefore, the correct quantization matrix used in encoding of the individual frames can be used to perform a decoding process.

In this manner, where the present invention is applied, even if random decoding is executed and an extended quantization matrix is described in the picture header of a frame which is not decoded, correct quantization matrices used in encoding of the individual frames can be used to perform a decoding process.

In other words, in each of encoded streams to be decoded, index data which is information indicative of a B picture in which an extended quantization matrix is described is produced as a pre-process to the decoding process.

Then, where index data formed from a quantization matrix flag described hereinabove with reference to FIG. 5 is used as the index data which is information indicative of a B picture in which an extended quantization matrix is described, the data amount of the index data can be suppressed.

Further, it is a matter of course that the index data may include various kinds of information other than information representative of a B picture in which an extended quantization matrix such as a quantization matrix flag is described. In other words, where it is possible to produce information necessary for a decoding process or suitably used in a decoding process as a pre-process to a decoding process, information indicative of a B picture in which an extended quantization matrix is described is produced as the information and used as index data.

By utilizing such index data to update a quantization matrix upon a decoding process, it is possible to prevent a malfunction where random decoding is performed thereby to suppress deterioration of the picture quality without performing some process for an original bit stream to be decoded or without increasing the data amount of an original bit stream.

Further, the process of referring to index data to update a quantization matrix does not have a significant influence also upon the entire decoding process because it can be executed at a high speed when compared with a decoding process.

Further, since index data or an index file in which the index data is described is managed in a file different from an original bit stream, it is possible, for example, to communicate the index data or the index file in which the index data is described and the original bit stream separately from each other between different apparatus. Further, since the index data or the index file in which the index data is described is managed in a file different from the original bit stream, the data size of the original bit stream is not varied and has no influence on the rate control of the bit stream.

It is to be noted that the processing described hereinabove can naturally be applied not only when random decoding is executed but also where some of frames of a GOP during reproduction is not decoded such as, for example, upon double speed reproduction.

It is to be noted that, although it is described here that a case wherein the MPEG is used as a codec method is taken as an example, the present invention can naturally be applied also where a coding process is performed using a quantization matrix and a frame correlation. For example, the present invention can be applied also to the AVC (Advance Video Coding)/H.264 and so forth.

It is to be noted that a B picture of the AVC/H.264 does not necessarily use reference images in both directions including a forward direction and a backward direction and may be predicted using two reference images in the past or using two reference images in the future. However, it is possible to apply the present invention taking such cases as just described into consideration, and where the present invention is applied, intervals in which a decoding process is performed using a wrong quantization matrix can be reduced and the deterioration of an image can be controlled.

The series of processes described above can be executed not only by hardware but also by software. A program which constructs the software is installed from a recording medium into a computer incorporated in hardware for exclusive use or, for example, a personal computer for universal use which can execute various functions by installing various programs.

The recording medium is formed from a removable medium 206 such as, as shown in FIG. 12, a magnetic disk (including a flexible disk), an optical disk (including a CD-ROM (Compact Disc-Read Only Memory) and a DVD (Digital Versatile Disk)), or a magneto-optical disk (including an MD (Mini-Disk) (trademark)), or a semiconductor memory which has the program recorded thereon or therein and is distributed to provide the program to a user separately from a computer.

Further, in the present specification, the steps which describe the program recorded in a recording medium may be but need not necessarily be processed in a time series in the order as described, and include processes which are executed in parallel or individually without being processed in a time series.

Further, in the present specification, the term system is used to represent an entire apparatus composed of a plurality of apparatus.

The network is a mechanism wherein at least two apparatus are connected such that information can be transmitted from a certain one to another one of the apparatus. The apparatus which communicate with each other through the network may be apparatus independent of each other or internal blocks which construct a single apparatus.

Further, the communication may be not only radio communication or wire communication but also communication wherein radio communication and wire communication are mixed, that is, communication wherein radio communication is performed within a certain interval and wire communication is performed within another interval. Further, the communication may be such that communication from a certain apparatus to a different apparatus is performed by wire communication and communication from the different apparatus to the certain apparatus is performed by radio communication.

The decoding apparatus may be an independent apparatus or a block which performs a decoding process in an information processing apparatus, a stream conversion apparatus, a transcoder, an editing apparatus or the like.

Further, the information processing apparatus may be an independent apparatus or a block which performs information processing in a decoding apparatus, a stream conversion apparatus, a transcoder, an editing apparatus or the like.

It is to be noted that the embodiment of the present invention is not limited to the embodiment described hereinabove but can be modified in various manners without departing from the spirit and scope of the present invention.

What is claimed is:

1. A decoding apparatus for decoding a bit stream, comprising:
bit stream acquisition means for acquiring the bit stream;
quantization matrix updating means for updating, before a start frame from which decoding of the bit stream is to be started and a reference image frame which is decoded in order to obtain a reference image necessary to decode the start frame are decoded respectively, a quantization matrix stored in a quantization matrix buffer such that, where a quantization matrix is described in any of B pictures disposed between the start frame to be decoded or the reference image frame and an I picture or a P picture preceding in time to the start frame or the reference image frame, the start frame and the reference image frame are decoded with the quantization matrix described in the B picture; and
decoding processing means for performing, where a quantization matrix is described in the frame to be decoded, a decoding process of the bit stream using the quantization matrix and updating said quantization matrix buffer using the quantization matrix, but performing, where a quantization matrix is not described in the frame to be decoded, a decoding process of the bit stream using the quantization matrix stored in said quantization matrix buffer.

2. The decoding apparatus according to claim 1, further comprising:
information acquisition means for acquiring information indicative of a B picture having a quantization matrix described in a picture header thereof;
said quantization matrix updating means being operable to decide, based on the information acquired by said information acquisition means, whether or not a quantization matrix is described in those B pictures which are positioned between the start frame and reference image frame and the I picture or P picture preceding in time to the start frame and the reference image frame and update, where it is decided that a quantization matrix is described in the B pictures, the quantization matrix stored in said quantization matrix buffer such that the start frame and the reference image frame are decoded with the quantization matrix described in the B pictures.

3. The decoding apparatus according to claim 2, wherein
the information acquired by said information acquisition means is formed from a set of one-bit flags provided individually corresponding to the frames which form the bit stream and indicative of whether or not a quantization matrix is described.

4. The decoding apparatus according to claim 1, further comprising:
information production means for deciding whether or not a quantization matrix is described in the B pictures included in the bit stream and producing information indicative of those B pictures which have a quantization matrix described;
said quantization matrix updating means being operable to decide, based on the information produced by said information production means, whether or not a quantization matrix is described in those B pictures which are positioned between the start frame and reference image frame and the I picture or P picture preceding in time to the start frame and the reference image frame and update, where it is decided that a quantization matrix is described in the B pictures, the quantization matrix stored in said quantization matrix buffer such that the start frame and the reference image frame are decoded with the quantization matrix described in the B pictures.

5. The decoding apparatus according to claim 4, wherein
the information produced by said information production means is formed from a set of one-bit flags provided individually corresponding to the frames which form the bit stream and indicative of whether or not a quantization matrix is described.

6. The decoding apparatus according to claim 1, wherein
the bit stream is an encoded stream encoded by the MPEG encoding system.

7. A decoding method for a decoding apparatus for decoding a bit stream, comprising the steps of:
acquiring the bit stream;
updating, before a start frame from which decoding of the bit stream is to be started and a reference image frame which is decoded in order to obtain a reference image necessary to decode the start frame are decoded respectively, a quantization matrix stored in a quantization matrix buffer such that, where a quantization matrix is described in any of B pictures disposed between the start frame to be decoded or the reference image frame and an I picture or a P picture preceding in time to the start frame or the reference image frame, the start frame and the reference image frame are decoded with the quantization matrix described in the B picture; and
performing, where a quantization matrix is described in the frame to be decoded, a decoding process of the bit stream using the quantization matrix and updating said quantization matrix buffer using the quantization matrix; but
performing, where a quantization matrix is not described in the frame to be decoded, a decoding process of the bit stream using the quantization matrix stored in said quantization matrix buffer.

8. An information processing apparatus for producing information to be used where a bit stream is decoded, comprising:
bit stream acquisition means for acquiring the bit stream; and
production means for deciding whether or not a quantization matrix is described in any of B pictures included in the bit stream acquired by said bit stream acquisition means and producing information indicative of the B picture which has a quantization matrix described in a picture header.

9. An information processing method for an information processing apparatus for producing information to be used where a bit stream is decoded, comprising the steps of:
acquiring the bit stream;
deciding whether or not a quantization matrix is described in any of B pictures included in the acquired bit stream; and
producing information indicative of the B picture which has a quantization matrix described in a picture header.
